(19) United States
(12) Patent Application Publication
(10) Pub. No.: US 2008/0192160 A1
(43) Pub. Date: Aug. 14, 2008

(54) LIQUID CRYSTAL DISPLAY DEVICE

(76) Inventors: Norihiro YOSHIDA, Kumagaya-shi (JP); Arihiro Takeda, Saitama-shi (JP); Jin Hirosawa, Saitama-shi (JP); Yoshitaka Yamada, Fukaya-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/028,526

(22) Filed: Feb. 8, 2008

(30) Foreign Application Priority Data
Feb. 14, 2007 (JP) 2007-034003

(51) Int. Cl. G02F 1/1335; G02F 1/1343

(52) U.S. Cl. 349/39; 349/114

(57) ABSTRACT

A liquid crystal display device includes a substrate, signal lines provided on the substrate, scanning lines which are perpendicular to the signal lines, switching elements which are provided at intersection portions between the signal lines, pixel electrodes and storage capacitance electrodes which are disposed in a matrix on the substrate, a contact hole which connects the pixel electrode and the switching element, or the switching element and the storage capacitance electrode, a counter-substrate which is disposed to be opposed to the substrate, a counter-electrode which is formed on the counter-substrate, and a liquid crystal layer which is held between the substrates and is formed of a liquid crystal with a negative dielectric constant anisotropy, the counter-electrode having an electrode missing part which is disposed at a position that is opposed to the contact hole.

### CROSS-REFERENCE TO RELATED APPLICATIONS

This application is based upon and claims the benefit of priority from prior Japanese Patent Application No. 2007-034003, filed Feb. 14, 2007, the entire contents of which are incorporated herein by reference.

### BACKGROUND OF THE INVENTION

1. Field of the Invention

The present invention relates generally to a liquid crystal display device, and more particularly to a liquid crystal display device of a vertical alignment mode.

2. Description of the Related Art

A liquid crystal display device has various features such as small thickness, light weight and low power consumption, and is applied to various uses, e.g. OA equipment, information terminals, timepieces, and TVs. In particular, a liquid crystal display device comprising thin-film transistors (TFTs) has high responsivity and, therefore, it is used as a monitor of a TV, a computer, etc., which displays a great deal of information.

In order to increase the display speed, consideration has been given to, in place of conventional display modes, an OCB mode, a VAN (Vertically Aligned Nematic) mode, a HAN (Hybrid Aligned Nematic) mode and a n alignment mode, which use nematic liquid crystals, and an SSFLC (Surface-Stabilized Ferroelectric Liquid Crystal) mode and an AFLC (Anti-Ferroelectric Liquid Crystal) mode, which use smectic liquid crystals.

Of these display modes, the VAN mode, in particular, has a higher response speed than the conventional TN (Twisted Nematic) mode. An additional feature of the VAN mode is that a rubbing process, which may lead to a defect such as an electrostatic breakage, can be made needless by vertical alignment. Particular attention is drawn to a multi-domain VAN mode in which the compensation design for a viewing angle is relatively easy (see, e.g. Japanese Patent No. 2565639).

Liquid crystal display devices are classified, according to display methods, into a reflective liquid crystal display device which makes use of ambient light, and a transmissive liquid crystal display device which makes use of backlight. In addition, there is known a transflective liquid crystal display device which adopts both the structures of the reflective liquid crystal display device and the transmissive liquid crystal display device.

In the transflective liquid crystal display device, a phase difference occurs in light passing through the liquid crystal layer between a transmissive display region and a reflective display region. Various means for eliminating such a phase difference have been proposed (see, e.g. Jpn. Pat. Appln. KOKAI Publication No. 2006-78742).

As regards the above-described liquid crystal display devices, however, in the case of a liquid crystal display device in which a short-side width of a pixel electrode is about 50 μm or less, there may occur an aperture ratio loss due to a protrusion disposed in the transmissive display region or light leakage at a part of an insulation layer due to a protrusion.

In addition, since a counter-electrode is not provided in a region of a counter-electrode missing pattern which is provided on the counter-substrate in order to control alignment, the electric field becomes lower in this region than in other regions. As a result, even at the time of application of voltage, the transmittance in the missing pattern region becomes lower than in the other regions.

Moreover, when voltage is applied, the region of the vicinity of a central part of the electrode missing part becomes a specific point in alignment of liquid crystal molecules, and this region transitions to an optically dark state. In short, in the vicinity of the central part of the electrode missing part, the transmittance decreases and loss in brightness may occur in some cases.

On the other hand, in the region where a contact hole, which is provided in the pixel electrode, is disposed, the thickness of the liquid crystal layer becomes different from a desired value due to the recess. Thus, a phase difference occurs in light between the region where the contact hole is disposed and the other region. Consequently, correct optical characteristics cannot be obtained in the region where the contact hole is disposed.

Further, there may be a case in which the state of alignment of liquid crystal molecules becomes unstable in the region where the contact hole is disposed, owing to the influence of the recess. As a result, when an image is displayed, there may occur degradation in quality of a screen image, such as persistence or roughness.

Besides, if there is a positional displacement between the central part of the electrode missing pattern and the part where the contact hole is disposed, the optical losses due to the respective parts may be combined and the optical characteristics of the liquid crystal display device may deteriorate.

### BRIEF SUMMARY OF THE INVENTION

The present invention has been made in consideration of the above-described problems, and the object of the invention is to provide a liquid crystal display device which suppresses degradation in optical characteristics and a decrease in quality of a display screen.

According to an aspect of the present invention, there is provided a liquid crystal display device comprising: an array substrate; a plurality of signal lines provided on the array substrate; a plurality of scanning lines which are perpendicular to the plurality of signal lines; switching elements which are provided at intersection portions between the signal lines and the scanning lines and are connected to the signal lines and the scanning lines; pixel electrodes and storage capacitance electrodes which are disposed in a matrix on the array substrate; a contact hole which connects the pixel electrode and the switching element, or the pixel electrode and the storage capacitance electrode; a counter-substrate which is disposed to be opposed to the array substrate, with a gap being formed therebetween; a counter-electrode which is formed on the counter-substrate; and a liquid crystal layer which is held between the array substrate and the counter-substrate and is formed of a liquid crystal with a negative dielectric constant anisotropy, the counter-electrode having an electrode missing part which is disposed at a position that is opposed to the contact hole.

The present invention can provide a liquid crystal display device which suppresses degradation in optical characteristics and a decrease in quality of a display screen.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an example of a liquid crystal display device according to a first embodiment of the present invention;

FIG. 2 is a view for describing an example of the structure of the liquid crystal display device shown in FIG. 1;

FIG. 3 is a cross-sectional view for describing in detail an example of the structure of the liquid crystal display device shown in FIG. 1;

FIG. 4 shows an example of a cross-sectional structure of an array substrate in the vicinity of an intersection between a scanning line and a signal line in the liquid crystal display device shown in FIG. 1;

FIG. 5 is a view for describing an example of the structure of a display pixel of a liquid crystal display device according to a first example of the liquid crystal display device of the first embodiment of the present invention;

FIG. 6 shows an example of a cross section of the display pixel shown in FIG. 5, the cross-section being taken along line VI-VI′ in FIG. 5;

FIG. 7 is a view for describing an example of the structure of a display pixel of a liquid crystal display device according to a first comparative example of the liquid crystal display device of the first embodiment of the invention;

FIG. 8 shows an example of a cross section of the display pixel shown in FIG. 7, the cross section being taken along line VIII-VIII′ in FIG. 5;

FIG. 9 is a view for describing an example of the structure of a display pixel of a liquid crystal display device according to a second example of the liquid crystal display device of the first embodiment of the invention;

FIG. 10 shows an example of a cross section of the display pixel shown in FIG. 9, the cross section being taken along line X-X′ in FIG. 9;

FIG. 11 is a view for describing an example of the structure of a display pixel of a liquid crystal display device according to a third example of the liquid crystal display device of the first embodiment of the invention;

FIG. 12 shows an example of a cross section of the display pixel shown in FIG. 11, the cross section being taken along line XII-XII′ in FIG. 11;

FIG. 13 is a table showing an example of the evaluation result of the liquid crystal display devices according to the examples and the comparative example of the liquid crystal display device of the first embodiment of the invention;

FIG. 14 is a view for describing an example of the structure of a display pixel of a liquid crystal display device according to a first example of a liquid crystal display device relating to a second embodiment of the present invention;

FIG. 15A shows an example of a cross section of the display pixel shown in FIG. 14, the cross-section being taken along line XV-XV′ in FIG. 14;

FIG. 15B shows another example of a cross section of the display pixel shown in FIG. 14, the cross-section being taken along line XV-XV′ in FIG. 14;

FIG. 16 is a view for describing an example of the structure of a display pixel of a liquid crystal display device according to a second example of the liquid crystal display device of the second embodiment of the invention;

FIG. 17A shows an example of a cross section of the display pixel shown in FIG. 16, the cross-section being taken along line XVII-XVII′ in FIG. 16;

FIG. 17B shows another example of a cross section of the display pixel shown in FIG. 16, the cross-section being taken along line XVII-XVII′ in FIG. 16;

FIG. 18 is a view for describing an example of the structure of a display pixel of a liquid crystal display device according to a first comparative example of the liquid crystal display device of the second embodiment of the invention;

FIG. 19A shows an example of a cross section of the display pixel shown in FIG. 18, the cross section being taken along line XIX-XIX′ in FIG. 18;

FIG. 19B shows another example of a cross section of the display pixel shown in FIG. 18, the cross section being taken along line XIX-XIX′ in FIG. 18;

FIG. 20 is a view for describing an example of the structure of a display pixel of a liquid crystal display device according to a second comparative example of the liquid crystal display device of the second embodiment of the invention;

FIG. 21A shows an example of a cross section of the display pixel shown in FIG. 20, the cross section being taken along line XXI-XXI′ in FIG. 20;

FIG. 21B shows another example of a cross section of the display pixel shown in FIG. 20, the cross section being taken along line XXI-XXI′ in FIG. 20; and

FIG. 22 is a table showing an example of the evaluation result of the liquid crystal display devices according to the examples and the comparative examples of the liquid crystal display device of the second embodiment of the invention.

### DETAILED DESCRIPTION OF THE INVENTION

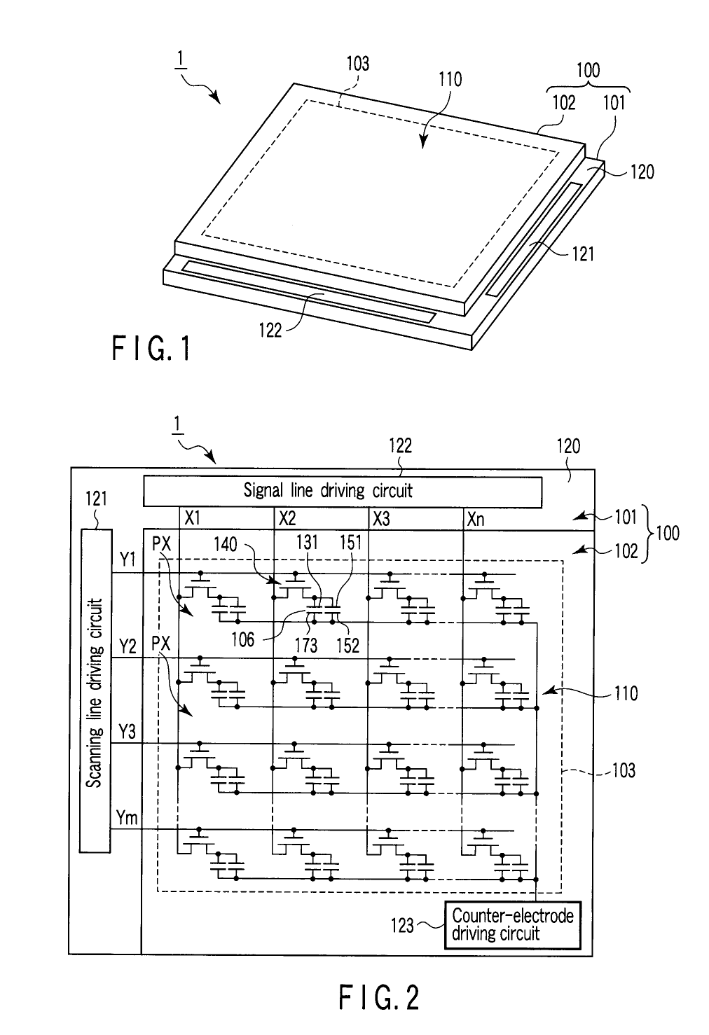

A first embodiment of a liquid crystal display device according to the present invention will now be described with reference to the accompanying drawings. A liquid crystal display device 1 according to the first embodiment comprises, as shown in FIG. 1, a liquid crystal display panel 100 which includes an array substrate 101, a counter-substrate 102 which is disposed to be opposed to the array substrate 101 with a gap being formed therebetween, and a liquid crystal layer 106 which is held between the array substrate 101 and the counter-substrate 102.

The liquid crystal display panel 100 has a display area 110 which is composed of a plurality of matrix-arrayed display pixels PX, and a peripheral area 120 which surrounds the display area 110. As shown in FIG. 1, the display area 110 is formed within a region surrounded by an outer edge seal member 103, and the peripheral area 120 is disposed along the outer periphery of the display area 110.

As shown in FIG. 2, a plurality of signal lines X1 to Xn and a plurality of scanning lines Y1 to Ym are disposed on the display area 110 so as to intersect with each other. In the peripheral area 120 shown in FIG. 1, the array substrate 101 includes a scanning line driving circuit 121 which drives the scanning lines Y1 to Ym, and a signal line driving circuit 122 which drives the signal lines X1 to Xn.

In the display area 110, the array substrate 101 includes an (m×n) pixel electrodes 131 which are disposed in the respective display pixels PX and are arranged in a matrix. On the other hand, the counter-substrate 102 includes a counter-electrode 173 which is opposed to all the pixel electrodes 131, with a liquid crystal 104 being interposed.

The liquid crystal 104 of the liquid crystal layer 106 has a negative dielectric constant anisotropy. In the state in which no voltage is applied between the pixel electrode 131 and the counter-electrode 173 or in the state in which a voltage less than a threshold value is applied therebetween, the liquid crystal 104 is aligned substantially vertical to the array substrate 101 or the counter-substrate 102.

On the other hand, in the state in which a voltage of the threshold value or more is applied between the pixel electrode 131 and the counter-electrode 173, the liquid crystal 104 is aligned oblique to or substantially parallel to the array substrate 101 or the counter-substrate 102. At this time, the liquid crystal 104 has such characteristics that the direction of inclination of the liquid crystal 104 is substantially determined by the direction of electric force lines 105.

The array substrate 101 includes an (m×n) number of thin-film transistors (TFTs) which are disposed as switching elements 140 near intersections between the scanning lines Y and signal lines X in association with the (m×n) pixel electrodes 131.

A source electrode 145 (shown in FIG. 4) of the switching element 140 is connected to the associated signal line X (or formed integral with the signal line X). A gate electrode 143 (shown in FIG. 4) of the switching element 140 is connected to the associated scanning line Y (or formed integral with the scanning line Y). A drain electrode 144 (shown in FIG. 4) of the switching element 140 is connected to the associated pixel electrode 131 (or formed integral with the pixel electrode 131).

In addition, the array substrate 101 includes storage capacitance electrodes 151 which are set at the same potential as the associated pixel electrodes 131. Further, the array substrate 101 includes storage capacitance lines 152 which are disposed to be opposed to the associated storage capacitance electrodes 151 and constitute storage capacitances between the storage capacitance lines 152 and the storage capacitance electrodes 151, and a counter-electrode driving circuit 123 which is connected to the storage capacitance lines 152 and the counter-electrode 173.

The counter-electrode driving circuit 123 executes control to set each storage capacitance line 152 and the counter-electrode 173 at a predetermined potential. The storage capacitance is constituted by each storage capacitance electrode 151 and the storage capacitance line 152 that is connected thereto.

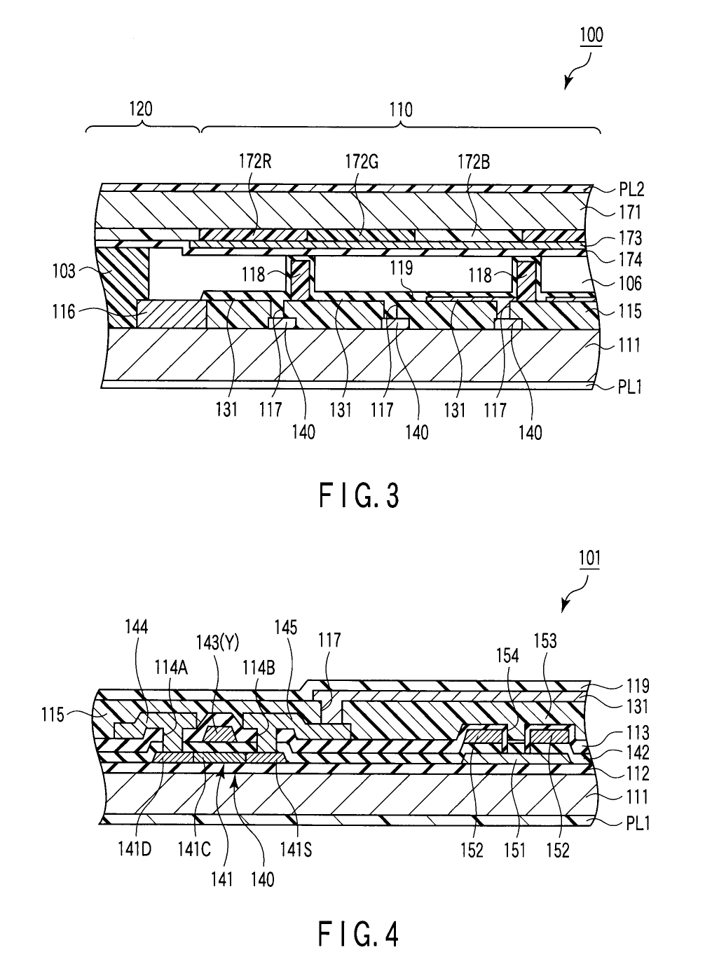

FIG. 3 is a cross-sectional view of the liquid crystal display panel 100 at a region near the boundary between the peripheral area 120 and the display area 110. FIG. 4 is a cross-sectional view of the array substrate 101 at a region near the intersection between the scanning line Y and signal line X shown in FIG. 2. The structural parts shown in FIG. 3 and FIG. 4 will be described below.

As shown in FIG. 3 and FIG. 4, the array substrate 101 includes a transparent insulative substrate 111 such as a glass substrate, and also includes a polarizer plate PL1 which is attached to the back side of the insulative substrate 111. In the display area 110, an undercoat layer 112 is disposed on the insulative substrate 111. The switching elements 140 are disposed on the undercoat layer 112.

The switching element 140 includes a semiconductor layer 141 which is formed of a polysilicon film on the undercoat layer 112. The semiconductor layer 141 comprises a channel region 141C, and a drain region 141D and a source region 141S which are formed by doping impurities on both sides of the channel region 141C. In addition, the storage capacitance electrode 151, which is formed of an impurity-doped polysilicon film, is disposed on the undercoat layer 112.

A gate insulation film 142 is formed on the undercoat layer 112, semiconductor layer 141 and storage capacitance electrode 151. The gate electrode 143, the scanning line Y that is integral with the gate electrode 143, and the storage capacitance line 152 are formed on the gate insulation film 142. A part of the storage capacitance line 152 is opposed to the storage capacitance electrode 151. The storage capacitance line 152 is formed of the same material as the scanning line Y and extends substantially parallel to the scanning line Y.

An interlayer insulation film 113 is disposed on the gate insulation film 142, gate electrode 143, scanning line Y and storage capacitance line 152. The drain electrode 144, signal line X, source electrode 145 and contact electrode 153 are disposed on the interlayer insulation film 113.

The signal line X is disposed substantially perpendicular to the scanning line Y and the storage capacitance line 152. The signal line X, scanning line Y and storage capacitance line 152 are formed of a low resistance material having light-blocking properties.

For example, the scanning line Y and storage capacitance line 152 are formed of molybdenum-tungsten. The signal line X is, in most cases, formed of aluminum. The drain electrode 144 and the source electrode 145 are connected to the drain region 141D and source region 141S via contact holes 114A and 114B that penetrate the gate insulation film 142 and interlayer insulation film 113.

The contact electrode 153 is connected to the storage capacitance electrode 151 via a contact hole 154 that penetrates the gate insulation film 142 and interlayer insulation film 113. The contact electrode 153 is formed of the same material as the drain electrode 144 and source electrode 145.

In the display area 110, a transparent resin layer 115 is further disposed on the interlayer insulation film 113, drain electrode 144, source electrode 145, scanning line Y, signal line X and contact electrode 153. In the peripheral area 120, a light-blocking layer 116 is further disposed.

The pixel electrode 131, which is formed of a light-transmissive electrically conductive material such as ITO (Indium Tin Oxide), is disposed on the transparent resin layer 115. The pixel electrode 131 is connected to the source electrode 145 of the switching element 140 via a contact hole 117 that penetrates the transparent resin layer 115. In addition, columnar spacers 118, each having a height of, e.g. 2.0 μm, are disposed on the transparent resin layer 115.

An alignment film 119 is disposed on the transparent resin layer 115 and pixel electrodes 131 so as to cover the columnar spacers 118. The alignment film 119 functions to align the liquid crystal 104 of the liquid crystal layer 106 in a direction substantially perpendicular to the substrate surface of the array substrate 101.

On the other hand, the counter-substrate 102 includes a transparent insulative substrate 171 such as a glass substrate, and a polarizer plate PL2 is attached to the front side of the insulative substrate 171. In the display area 110, the counter-substrate 102 includes a red color filter layer 172R, a green color filter layer 172G and a blue color filter layer 172B, which are disposed on the insulative substrate 171. The counter-electrode 173 is disposed on the color filters so that the counter-electrode 173 may be opposed to all the pixel electrodes 131.

The counter-electrode 173 is formed of a light-transmissive electrically conductive material such as ITO. An alignment film 174 is disposed on the counter-electrode 173. The alignment film 174 functions to align the liquid crystal 104 of the liquid crystal layer 106 in a direction substantially perpendicular to the substrate surface of the counter-substrate 102. The array substrate 101 and counter-substrate 102 are attached to each other via the outer edge seal member 103.

The alignment film 119 is directly formed on the pixel electrodes 131, and the alignment film 174 is directly formed on the counter-electrode 173. In addition, protrusions, or the like, may be formed of an insulation film as means for aligning liquid crystal molecules. This insulation film is, for example, an inorganic thin film of SiO₂, SiNx or Al₂O₃, or an organic thin film of polyimide, photoresist resin or high-polymer liquid crystal.

In the case where the insulation film is an inorganic thin film, the insulation film may be formed by evaporation deposition, sputtering, CVD (Chemical Vapor Deposition) or a solution coating method. In the case where the insulation film is an organic thin film, the following methods may be adopted. For example, a solution of an organic substance or a solution of a precursor thereof is used and is coated by a spinner coating method, a screen print coating method or a roll coating method, and the coated film is cured under predetermined curing conditions (e.g. heating, light radiation). Alternatively, the insulation film may be formed by evaporation deposition, sputtering, CVD, or LB (Langumuir-Blodgett) method.

The liquid crystal display device 1 according to the present embodiment includes an area light source unit (not shown) which is disposed on the back side of the liquid crystal display panel 100. The area light source unit includes, for example, a cold cathode tube as a light source, a light guide which guides light that is emitted from the cold cathode tube to the liquid crystal display panel 100 side, and various optical sheets.

Next, examples and a comparative example of the liquid crystal display device 1 according to the present embodiment will be described. These examples are described for the purpose of easier understanding of the present invention, and do not restrict the scope of the invention. Further, the present invention may be variously modified in use without departing from the spirit of the invention.

To begin with, a first example of the liquid crystal display device 1 according to the present embodiment is described. In this example, the liquid crystal display device 1 includes a liquid crystal display panel 100 in which the pitch of arrangement of display pixels PX is about 300 ppi. The size of the display pixel PX is about 90 μm in the long side and about 30 μm in the short side.

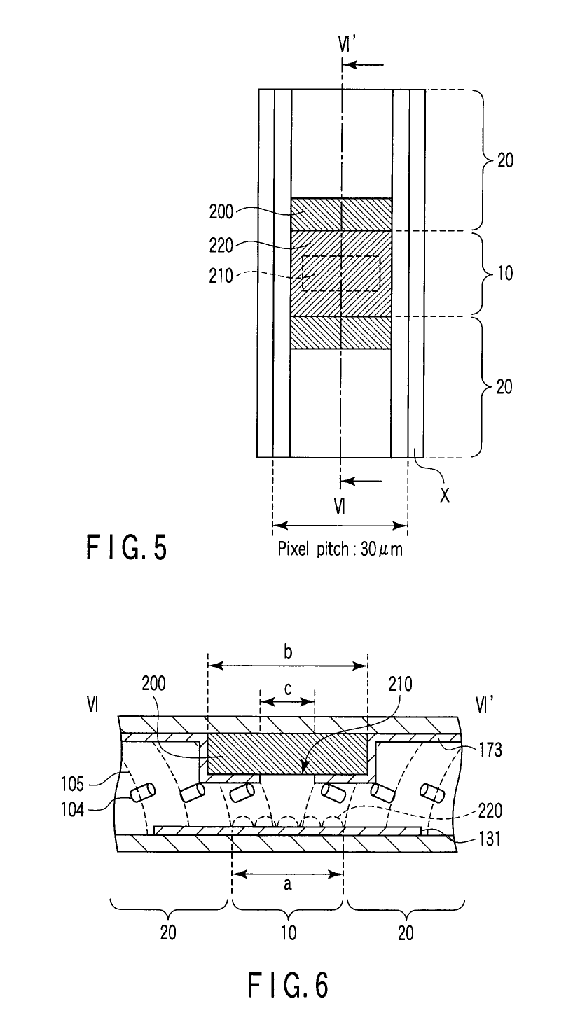

In the liquid crystal display panel 100, the array substrate 101 and counter-substrate 102 are formed by the process described in the embodiment so as to have a pixel structure as shown in FIG. 5 and FIG. 6.

Specifically, the pixel electrode 131 includes a transmissive electrode and a reflective electrode 220 which has a projection-and-recess-shaped surface. Accordingly, the liquid crystal display device 1 of the present example is a transflective liquid crystal display device. A resin insulation layer 200 is disposed on the counter-substrate 102 so as to be opposed to the reflective electrode 220 of the array substrate 101, and a counter-electrode 173 is disposed on the resin insulation layer 200.

The counter-electrode 173 has an electrode missing part 210 at a position that is opposed to the reflective electrode 220. Specifically, the electrode missing part 210 of the counter-electrode 173 is provided on the resin insulation layer 200. The electrode missing part 210 restricts the direction of the tilt of the liquid crystal 104 of the liquid crystal layer 106 when a voltage is applied to the liquid crystal layer 106. In other words, when a voltage is applied to the liquid crystal layer 106, the liquid crystal 104 of the liquid crystal layer 106 tilts toward the electrode missing part 210, as shown in FIG. 6.

In this example, the width a of the reflective electrode 220 of the array substrate 101 is set at about 30 μm, and the width b of the resin insulation layer 200 disposed on the counter-substrate 102 is set at about 40 μm. The electrode missing part 210 is disposed such that the short side width c thereof is about 10 μm.

Accordingly, as shown in FIG. 5 and FIG. 6, the resin insulation layer 200 is disposed so as to cover the reflective electrode 220. In short, the resin insulation layer 200 is opposed to the reflective electrode 220. The electrode missing part 210 is disposed on the resin insulation layer 200 so as to face the reflective electrode 220.

Alignment films (not shown), which exhibit verticality, were coated with a thickness of about 100 nm on the array substrate 101 and the counter-substrate 102, and the liquid crystal display panel 100 was assembled by the ordinary process. Then, the liquid crystal 104 with a negative dielectric constant anisotropy was filled in the liquid crystal display panel 100, and the liquid crystal display panel 100 was assembled in the liquid crystal display device 1.

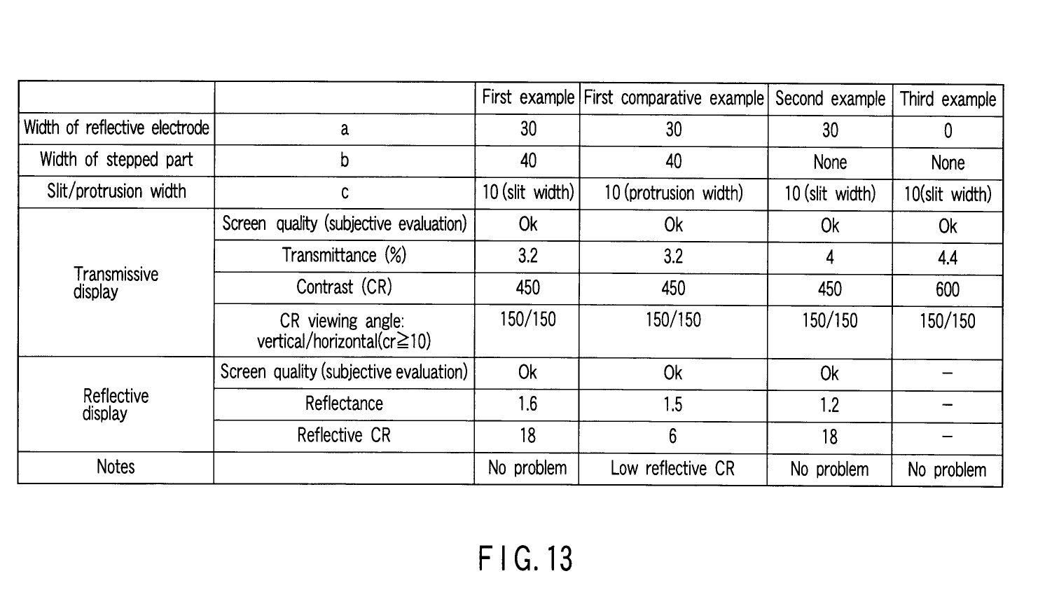

FIG. 13 shows a result of evaluation of the liquid crystal display device 1. As shown in FIG. 13, in the case of this liquid crystal display device 1, no problem occurred in the transmissive display and reflective display.

Next, a first comparative example of the liquid crystal display device 1 according to the present embodiment is described. In this example, the liquid crystal display device 1 includes a liquid crystal display panel 100 in which the pitch of arrangement of display pixels PX is about 300 ppi. The size of the display pixel PX is about 90 μm in the long side and about 30 μm in the short side.

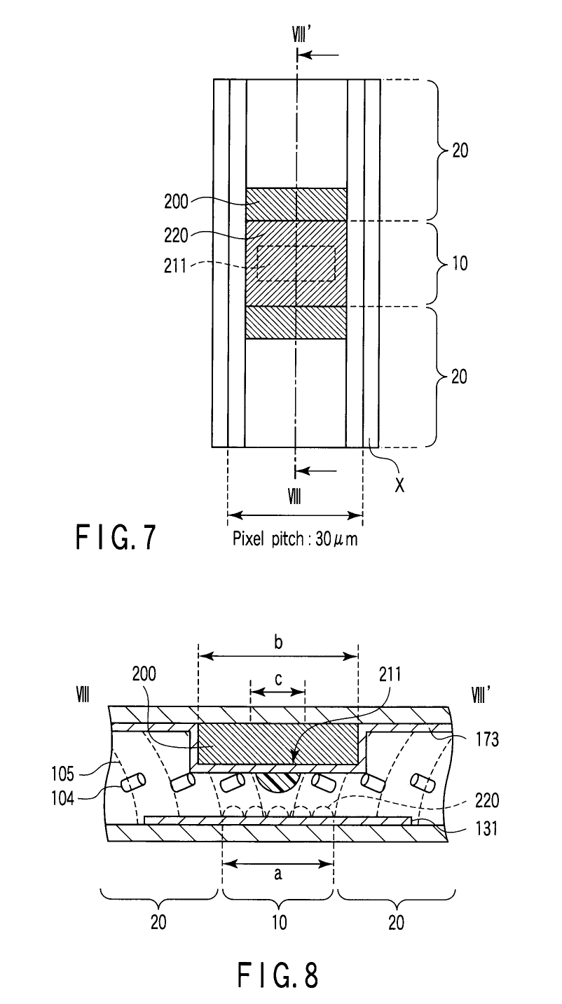

In the liquid crystal display panel 100, the array substrate 101 and counter-substrate 102 are formed by the process described in the above embodiment so as to have a pixel structure as shown in FIG. 7 and FIG. 8. In this comparative example, the pitch of arrangement of display pixels PX is the length of the short side of the pixel electrode 131.

Specifically, like the liquid crystal display device of the above-described first example, the pixel electrode 131 includes a transmissive electrode and a reflective electrode 220 which has a projection-and-recess-shaped surface. Accordingly, the liquid crystal display device 1 of the present comparative example is a transflective liquid crystal display device. A resin insulation layer 200 is disposed on the counter-substrate 102 so as to be opposed to the reflective electrode 220.

A counter-electrode 173 is disposed on the resin insulation layer 200, and a protrusion 211 is disposed on the counter-electrode 173 so as to face the reflective electrode 220. The protrusion 211 restricts the direction of the tilt of the liquid crystal 104 of the liquid crystal layer 106 when a voltage is applied to the liquid crystal 104. In other words, when a voltage is applied to the liquid crystal layer 106, the liquid crystal 104 tilts toward the protrusion 211, as shown in FIG. 8.

In the liquid crystal display device 1 of this comparative example, the width a of the reflective electrode 220 is set at about 30 μm, and the width b of the resin insulation layer 200 disposed on the counter-substrate 102 is set at about 40 μm. The width c of the protrusion 211 is set at about 10 μm.

Accordingly, as shown in FIG. 7 and FIG. 8, the resin insulation layer 200 is disposed so as to cover the reflective electrode 220. In short, the resin insulation layer 200 is opposed to the reflective electrode 220. The protrusion 211 is disposed on the resin insulation layer 200 so as to face the reflective electrode 220.

Alignment films (not shown), which exhibit verticality, were coated with a thickness of about 100 nm on the array substrate 101 and the counter-substrate 102, and the liquid crystal display panel 100 was assembled by the ordinary process. Then, the liquid crystal 104 with a negative dielectric constant anisotropy was filled in the liquid crystal display panel 100, and the liquid crystal display panel 100 was assembled in the liquid crystal display device 1.

FIG. 13 shows a result of evaluation of the above-described liquid crystal display device 1. As shown in FIG. 13, in the case of this liquid crystal display device 1, no problem occurred in the transmissive display and reflective display. However, the reflective contrast was lower than in the liquid crystal display device 1 according to the first example.

Next, a second example of the liquid crystal display device 1 according to the present embodiment is described. In this example, the liquid crystal display device 1 includes a liquid crystal display panel 100 in which the pitch of arrangement of display pixels PX is about 300 ppi. The size of the display pixel PX is about 90 μm in the long side and about 30 μm in the short side.

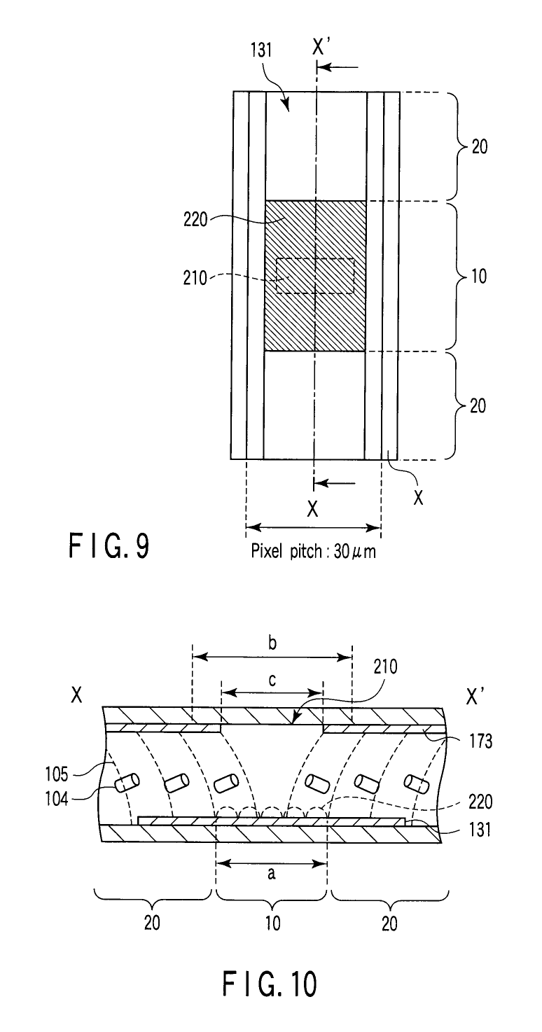

In the liquid crystal display panel 100, the array substrate 101 and counter-substrate 102 are formed by the process described in the above embodiment so as to have the pixel structure as shown in FIG. 9 and FIG. 10. In the liquid crystal display device 1 of this second example, unlike the liquid crystal display device 1 of the first example, the counter-substrate 102 does not include the resin insulation layer 200.

On the other hand, like the liquid crystal display device 1 of the first example, the pixel electrode 131 includes a transmissive electrode and a reflective electrode 220 which has a projection-and-recess-shaped surface. Accordingly, the liquid crystal display device 1 of the present example is a transflective liquid crystal display device. The counter-electrode 173 has an electrode missing part 210 which faces the reflective electrode 220.

In this example, the width a of the reflective electrode 220 of the array substrate 101 was set at about 30 μm. An electrode missing part 210, which restricts the direction of the tilt of the liquid crystal 104, is provided on the counter-substrate 102, and the short side width c of the electrode missing part 210 was set at about 10 μm.

Alignment films (not shown), which exhibit verticality, were coated with a thickness of about 100 nm on the array substrate 101 and the counter-substrate 102, and the cell was assembled by the ordinary process. Then, the liquid crystal 104 with a negative dielectric constant anisotropy was filled in the cell, and the module was assembled.

FIG. 13 shows a result of evaluation of the liquid crystal display device 1 according to this example. As shown in FIG. 13, in the case of this liquid crystal display device 1, no particular problem occurred in the display, although the reflectance at the time of reflective display was slightly low.

Next, a third example of the liquid crystal display device 1 according to the present embodiment is described. In this example, the liquid crystal display device 1 includes a liquid crystal display panel 100 in which the pitch of arrangement of display pixels PX is about 300 ppi. The size of the display pixel PX is about 90 μm in the long side and about 30 μm in the short side.

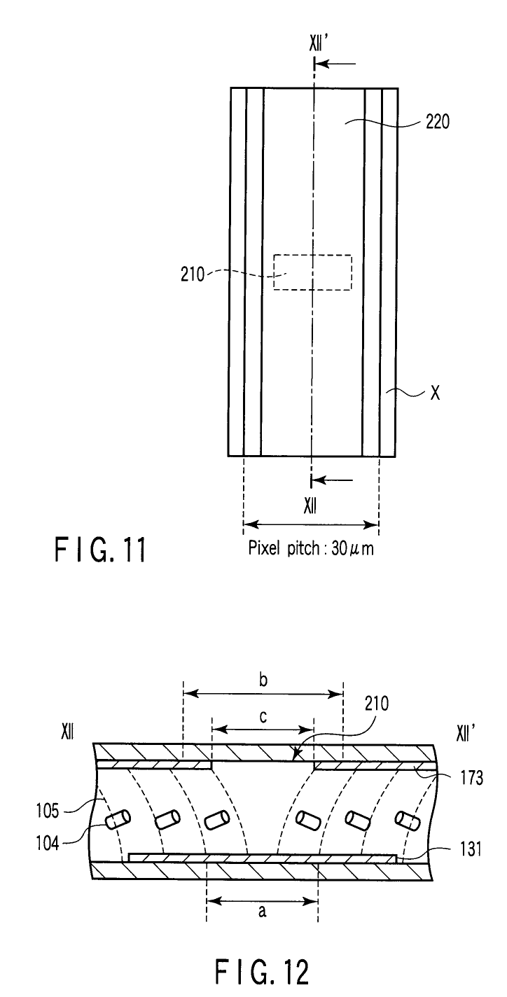

In the liquid crystal display panel 100, the array substrate 101 and counter-substrate 102 were formed by the process described in the above embodiment so as to have a pixel structure as shown in FIG. 11 and FIG. 12.

Specifically, as shown in FIG. 11 and FIG. 12, the pixel electrode 131 of the liquid crystal display device 1 of this example includes only the transmissive electrode, and does not include the reflective electrode 220. Accordingly, the liquid crystal display device 1 of this example is a transmissive liquid crystal display device.

The counter-electrode 173 has an electrode missing part 210 which faces the transmissive electrode of the pixel electrode 131. The width c in the short-side direction of the electrode missing part 210 was set at about 10 μm.

FIG. 13 shows a result of evaluation of the liquid crystal display device according to this example. As shown in FIG. 13, although the liquid crystal display device of this example is unable to perform reflective display, no problem occurred in the transmissive display.

In the above-described examples and comparative example relating to the present embodiment, the electrode missing part 210 has a substantially rectangular shape with the width c of about 10 μm and the length of about 20 μm. However, if the width is about 5 μm and the length is about 5 μm or more, the shape of the electrode missing part is not restricted.

As regards the relationship in dimension between the width a of the reflective electrode 220 and the width b of the resin insulation layer 200 of the counter-electrode 102, the width b of the resin insulation layer 200 of the counter-electrode 102 has to be greater than the width a of the reflective electrode 220.

Specifically, in the case where the width b of the resin insulation layer 200 of the counter-electrode 102 is less than the width a of the reflective electrode 220 and a reflective display region 10 includes a part where the thickness of the liquid crystal layer 106 is the same as in a transmissive display region 20, the color and gradation at the time of reflective display may deviate from optimal ones, and the display quality may deteriorate.

On the other hand, as is understood from the above result, in the case where the width b of the resin insulation layer 200 of the counter-electrode 102 is greater than the width a of the reflective electrode 220 and the thickness of the liquid crystal layer 106 in the reflective display region 10 is less than the thickness of the liquid crystal layer 106 in the transmissive display region 20, no abnormality occurs in the color and gradation even at the time of reflective display, and a good display condition can be attained at the time of transmissive display.

As regards the vertical-alignment liquid crystal display device, there is a case in which a viewing angle compensation plate is used so that the viewing angle characteristics may become better as the transmittance becomes lower. In this case, a part with the same thickness of the liquid crystal layer as in the reflective display region 10 is formed in the transmissive display region 20. Thereby, the part with low transmittance is mixedly included, and the contrast viewing angle increases and the viewing angle characteristics are improved.

Further, in cases other than the above-described examples, if the resin insulation layer 200 is not formed in the reflective display region 10 and an electrode missing part 210 with a greater width than the reflective electrode 220 is formed, the voltage at the electrode missing part 210 becomes lower than at the part where the electrode missing part 210 is not provided on the counter-electrode 172, although the thickness of the liquid crystal layer of the reflective display region 10 is greater than the optimal condition. Thus, an optimal value was obtained for the phase variation of the liquid crystal layer 106.

Thus, in this case, in the fabrication process of the liquid crystal display device, the process of forming the resin simulation layer 200 can be eliminated, and the display quality at the time of transmissive display and reflective display can be improved.

Specifically, the above-described first embodiment can provide a liquid crystal display device which can prevent occurrence of abnormality in color and gradation in the reflective display region 10, and can suppress degradation in optical characteristics and deterioration in display screen quality.

In the liquid crystal display device according to the first embodiment, the reflective display region 10 is disposed substantially in parallel with the short sides of the display pixel PX at the central part along the long sides of the display pixel PX. Thereby, the state of alignment of liquid crystal molecules included in the liquid crystal 104 can be made substantially symmetric on the upper and lower sides of the reflective display region.

Moreover, in the liquid crystal display device according to the first embodiment, the width of the short side of the pixel electrode 131 is set at 50 μm or less. Thereby, when a voltage is applied to the liquid crystal 104, even the electric force lines, which are generated near the end edges of the display pixel PX, are also tilted due to the influence of the electrode missing part 210.

Thus, by disposing the reflective display region 10 substantially in parallel with the short sides of the display pixel PX at the central part along the long sides of the display pixel PX and by setting the short side width of the pixel electrode 131 at about 50 μm or less, the direction of the tilt of the liquid crystal molecules can be restricted in the entirety of the display pixel PX.

Next, a liquid crystal display device according to a second embodiment of the present invention will now be described with reference to the accompanying drawings. In the description below, the structural parts common to those of the liquid crystal display device 1 according to the first embodiment are denoted by like reference numerals, and a description thereof is omitted.

The liquid crystal display device 1 according to the second embodiment comprises, like the first embodiment, a liquid crystal display panel 100 which includes an array substrate 101, a counter-substrate 102 which is disposed to be opposed to the array substrate 101 with a gap being formed therebetween, and a liquid crystal layer 106 which is held between the array substrate 101 and the counter-substrate 102.

The liquid crystal display panel 100 has a display area 110 which is composed of a plurality of matrix-arrayed display pixels PX. The array substrate 101 includes pixel electrodes 131 which are disposed in the respective display pixels PX.

The pixel electrode 131 includes a transmissive electrode which is disposed at least in a transmissive display region 20, and a reflective electrode 220 which is disposed in a reflective display region 10. The reflective electrode 220 has a projection-and-recess-shaped surface. Accordingly, the liquid crystal display device 1 of the present embodiment is a transflective liquid crystal display device.

A pixel electrode 131 and a storage capacitance electrode 151 on the array substrate 101 are disposed in different layers, with an insulation layer being interposed, in such a manner that the pixel electrode 131 and the storage capacitance electrode 151 are opposed to each other. The pixel electrode 131 and storage capacitance electrode 151 are electrically connected by a contact electrode 153 via a contact hole 134. Further, the pixel electrode 131 and storage capacitance electrode 151 are connected to the signal line X via the switching element 140.

Like the above-described first embodiment, the array substrate 101 includes storage capacitance lines 152 which are disposed to be opposed to the associated storage capacitance electrodes 151 and constitute storage capacitances between the storage capacitance lines 152 and the storage capacitance electrodes 151, and a counter-electrode driving circuit 123 which is connected to the storage capacitance lines 152 and the counter-electrode 173. The counter-electrode driving circuit 123 executes control to set each storage capacitance line 152 and the counter-electrode 173 at a predetermined potential. The storage capacitance is constituted by each storage capacitance electrode 151 and the storage capacitance line 152 that is connected thereto.

The pixel electrode 131 and storage capacitance electrode 151 may be directly connected via the contact hole 134, without intervention of the contact electrode 153. In the drawings mentioned below, for the purpose of the convenience of description of the embodiment, depiction of the switching element 140, storage capacitance line 152, contact electrode 153 and signal line X is omitted.

In the liquid crystal display device 1 according to the present embodiment, the contact hole 134 is disposed in the reflective display region 10 of the display pixel PX.

The counter-substrate 102 includes a counter-electrode 173 which is opposed to all the pixel electrodes 131 of the array substrate 101. Like the liquid crystal display device 1 according to the first embodiment, the counter-electrode 173 is formed by sputtering ITO.

The pattern of the electrode missing part 210 of the counter-electrode 173 was formed by PEP. Although not shown, vertical alignment films, which are formed of polyimide as a main ingredient, are provided on those sides of the array substrate 101 and counter-substrate 102, which face the liquid crystal layer 106.

In the liquid crystal display device 1 of the present embodiment, the electrode missing part 210 of the counter-electrode 173 and the contact hole 134 of the array substrate 101 are disposed at the same position. In short, the contact hole 134 is disposed to be opposed to the electrode missing part 210.

In addition, in the liquid crystal display device 1 of the present embodiment, like the liquid crystal display device of the above-described first embodiment, the liquid crystal layer 106 includes a nematic liquid crystal material which has a negative dielectric constant anisotropy.

Furthermore, the liquid crystal display device 1 of the present embodiment includes an area light source unit which is disposed on the back side of the liquid crystal display panel 100. The area light source unit includes, for example, a cold cathode tube L as a light source, a light guide 40 which guides light that is emitted from the cold cathode tube L to the liquid crystal display panel 100 side, and various optical sheets (not shown).

Next, a first example of the liquid crystal display device 1 according to the second embodiment is described with reference to the accompanying drawings. The liquid crystal display device 1 according to this example includes a liquid crystal display panel 100 in which the pitch of arrangement of display pixels PX is about 166 ppi, and the number of display pixels is 320(vertical)×240 (horizontal). The size of the display pixel PX is about 150 μm in the long side and about 50 μm in the short side.

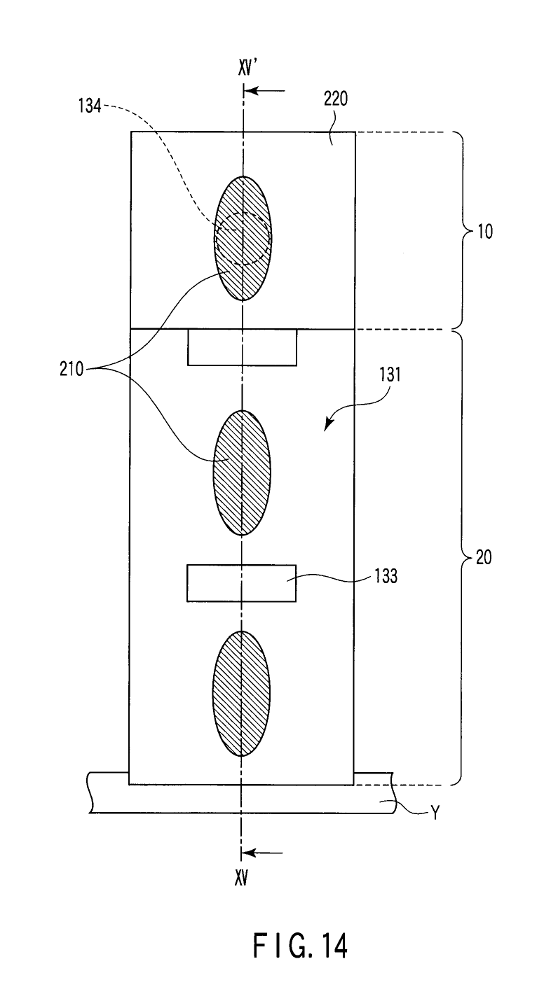

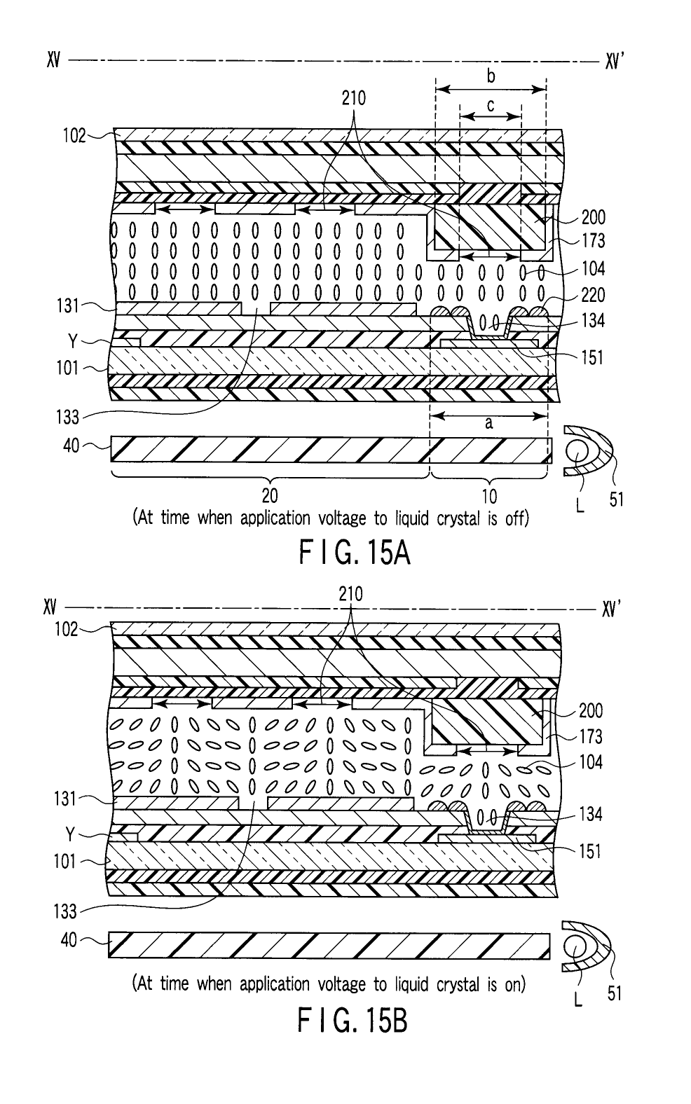

As shown in FIG. 14, FIG. 15A and FIG. 15B, the array substrate 101 has an electrode missing part 133 in each pixel electrode 131. In other words, the pixel electrode 131 is divided into a plurality of regions by the electrode missing part 133.

The counter-electrode 173 includes a resin insulation layer 200 which is disposed in the reflective display region 10 of the display pixel PX. In the liquid crystal display device 1 of the present example, the resin insulation layer 200 is disposed in a layer under the counter-electrode 173.

The counter-electrode 173 includes electrode missing parts 210. In the liquid crystal display device 1 of the present example, as shown in FIG. 14, in each display pixel PX, two electrode missing parts 210 are disposed in the transmissive display region 20, and one electrode missing part 210 is disposed in the reflective display region 10.

The electrode missing part 210 of the counter-electrode 173 functions to control the alignment of the liquid crystal 104 of the liquid crystal layer 106. Specifically, as shown in FIG. 15A and FIG. 15B, in the state in which no voltage is applied to the liquid crystal layer 106, the major axis (director) of the liquid crystal 104 is aligned substantially perpendicular to the array substrate 101 and counter-substrate 102. In the state in which a voltage is applied to the liquid crystal layer 106, the major axis (director) of the liquid crystal 104 is aligned substantially perpendicular to the electric force lines which are generated between the pixel electrode 131 and the counter-electrode 173. Accordingly, when a voltage is applied to the liquid crystal layer 106, the liquid crystal 104 is aligned so as to tilt toward the electrode missing part 210.

As described above, by providing the counter-electrode 173 with the electrode missing parts 210, the direction of the electric force lines, which are generated between the pixel electrode 131 and the counter-electrode 173, can be adjusted and the alignment of the liquid crystal 104 can be controlled.

In the liquid crystal display device according to the present example, the electrode missing part 210, which is disposed in the reflective display region 10, is disposed so as to overlap with the contact hole 134. In other words, as shown in FIG. 14, the contact hole 134 is so disposed as to face a central part of the electrode missing part 210.

In this example, the central part of the electrode missing part 210 is a part where the major axis and minor axis of the substantially elliptic electrode missing part 210 intersect. In the liquid crystal display device according to the present example, the width a of the reflective electrode 220 in the long-side direction of the pixel electrode 131 is 100 μm, the width b of the resin insulation layer 200 is 50 μm, and the width c of the electrode missing part 210 is 10 μm. In addition, in the liquid crystal display device 1 according to the present example, the width in the short-side direction of the electrode missing part 210 is about 10 μm, and the width in the short-side direction of the contact hole 134 is about 8 μm.

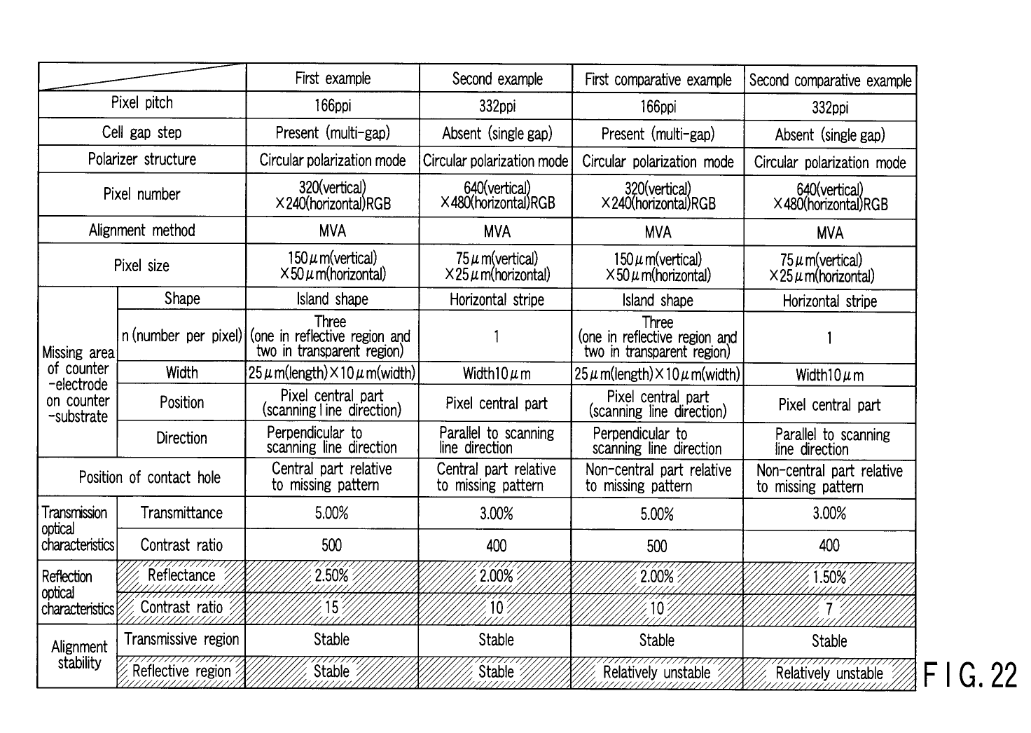

FIG. 22 shows a result of evaluation of the above-described liquid crystal display device. As shown in FIG. 22, in the liquid crystal display device 1 of the present example, both the reflectance and contrast ratio at the time of reflective display were good, and the liquid crystal alignment state in the reflective display region 10 was stable.

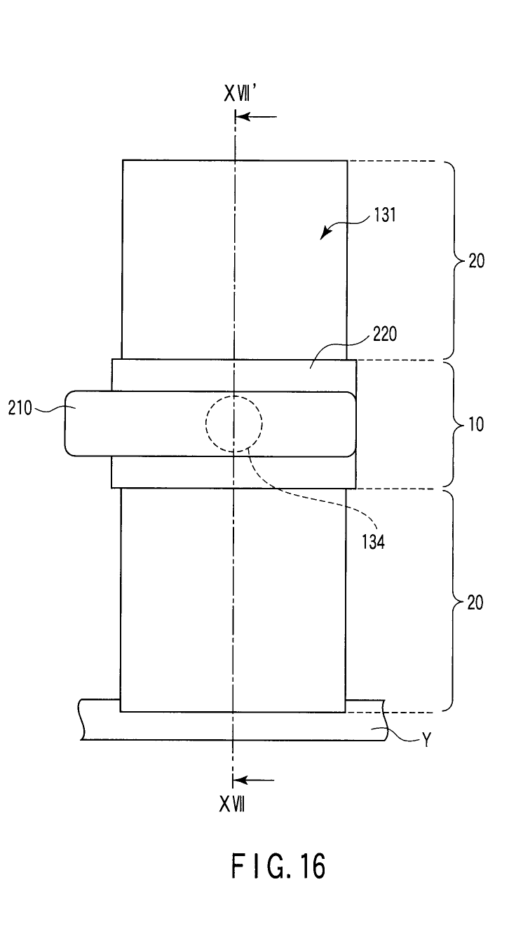

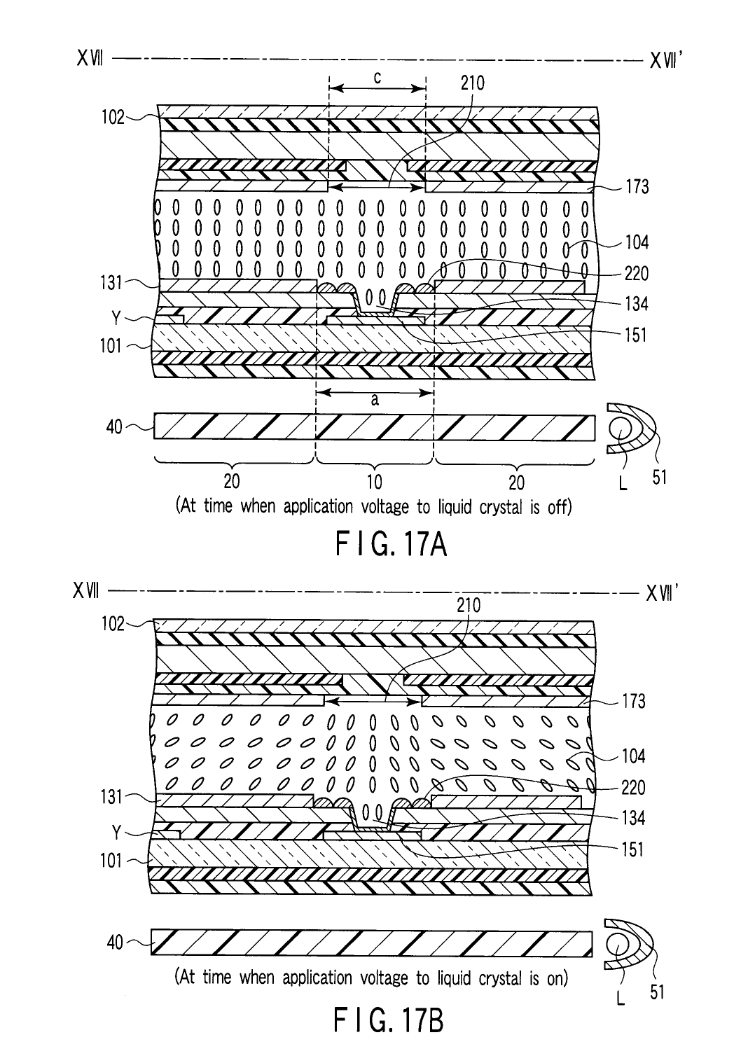

Next, a liquid crystal display device according to a second example of the present embodiment is described with reference to the accompanying drawings. As shown in FIG. 16, FIG. 17A and FIG. 17B, in the liquid crystal display device according to this example, a reflective display region 10 is disposed at a central part in the long-side direction of the display pixel PX so as to cross the display pixel PX. Transmissive display regions 20 are disposed on both sides of the reflective display area 10. In other words, in the liquid crystal display device 1 according to this example, the reflective display region 10 extends substantially parallel to the short sides of the pixel electrode 131.

In the liquid crystal display device 1 according to this second example, like the liquid crystal display device according to the above-described first example, the pixel electrode 131 and storage capacitance electrode 151 are electrically connected via the contact hole 134.

The counter-electrode 173 includes an electrode missing part 210. In the liquid crystal display device of the present example, the electrode missing part 210 is provided at one location in the reflective display area 10 in each display pixel 10. The electrode missing part 210 restricts the direction of the tilt of the liquid crystal 104 when a voltage is applied to the liquid crystal layer 106.

Specifically, as shown in FIG. 17A and FIG. 17B, in the state in which no voltage is applied to the liquid crystal layer 106, the major axis (director) of the liquid crystal 104 is aligned substantially perpendicular to the array substrate 101 and counter-substrate 102. In the state in which a voltage is applied to the liquid crystal layer 106, the major axis (director) of the liquid crystal 104 is aligned substantially perpendicular to the electric force lines which are generated between the pixel electrode 131 and the counter-electrode 173. Accordingly, when a voltage is applied to the liquid crystal layer 106, the liquid crystal 104 is aligned so as to tilt toward the electrode missing part 210.

In the planar direction of the array substrate 101, the electrode missing part 210 is disposed at a position overlapping with the contact hole 134. In other words, in the liquid crystal display device according to the present example, the central part of the contact hole 134 is positioned at the central part of the electrode missing part 210, and is opposed to the electrode missing part 210.

In the present example, the central part of the electrode missing part 210 is a part where the distance from the long sides of the electrode missing part 210 is equal and the distance from the short sides is equal. In the liquid crystal display device according to the present example, the width in the short-side direction of the contact hole 134 is about 8 μm. In addition, in the liquid crystal display device according to the present example, the width a of the reflective electrode 220 in the long-side direction of the pixel electrode 131 is 50 μm, and the width c of the electrode missing part 210 is 10 μm.

FIG. 22 shows a result of evaluation of the above-described liquid crystal display device. As shown in FIG. 22, in the liquid crystal display device of the present example, both the reflectance and contrast ratio at the time of reflective display were good, and the liquid crystal alignment state in the reflective display region 10 was stable.

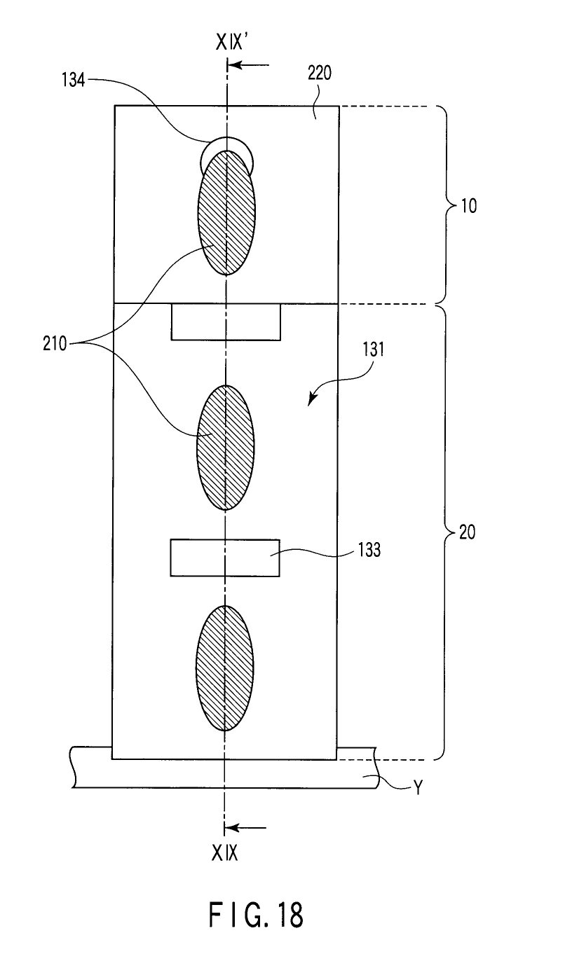

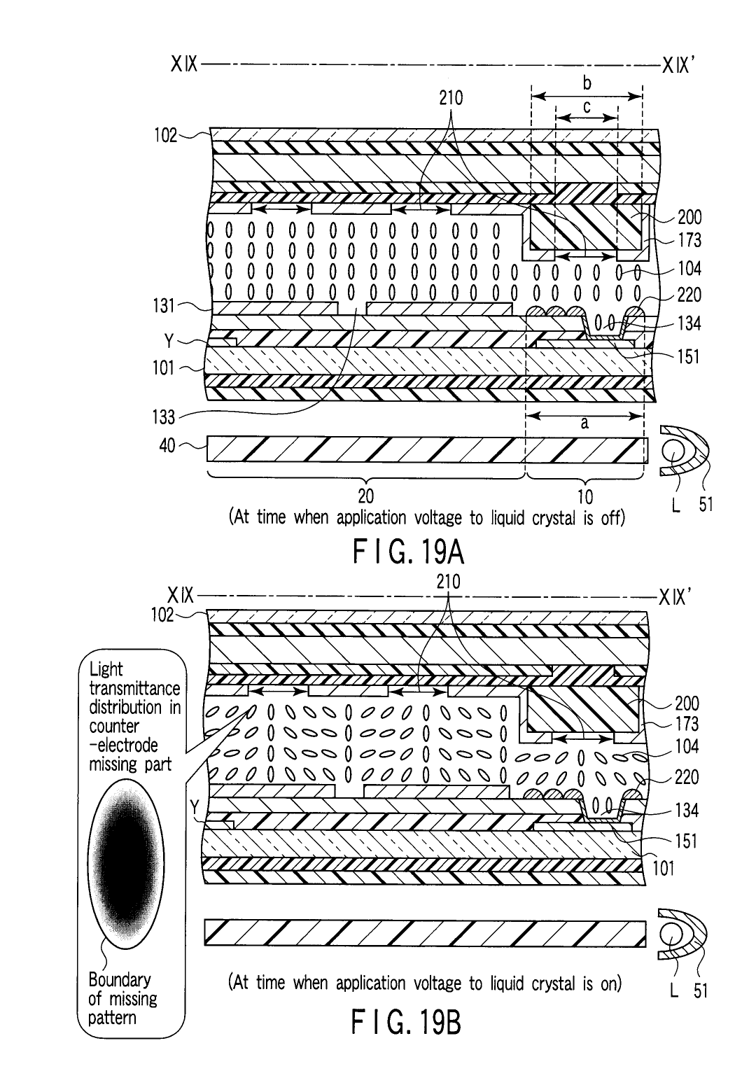

Next, a first comparative example of the liquid crystal display device according to the present embodiment is described with reference to the accompanying drawings. As shown in FIG. 18, FIG. 19A and FIG. 19B, the liquid crystal display device according to the present comparative example is the same as the liquid crystal display device according to the first example, except for the position of the contact hole 134.

Specifically, in the liquid crystal display device according to the present comparative example, the central position of the contact hole 134 is displaced from the central position of the electrode missing part 210. Thus, there is a part where the contact hole 134 does not overlap the electrode missing part 210, and the part, where the contact hole 134 overlaps the electrode missing part 210, decreases.

FIG. 22 shows a result of evaluation of the above-described liquid crystal display device. As shown in FIG. 22, in the liquid crystal display device of the present comparative example, both the reflectance and contrast ratio at the time of reflective display were good, but the liquid crystal alignment state in the reflective display region 10 was relatively unstable.

As shown in FIG. 19A and FIG. 19B, in the electrode missing part 210 of the counter-electrode 173, the transmittance decreases from the edge portion of the electrode missing part 210 toward the central portion of the electrode missing part 210. Thus, if the part, where the electrode missing part 210 and contact hole 134 do not overlap, increases, the part with low transmittance increases in the display area 110 of the liquid crystal display panel 100.

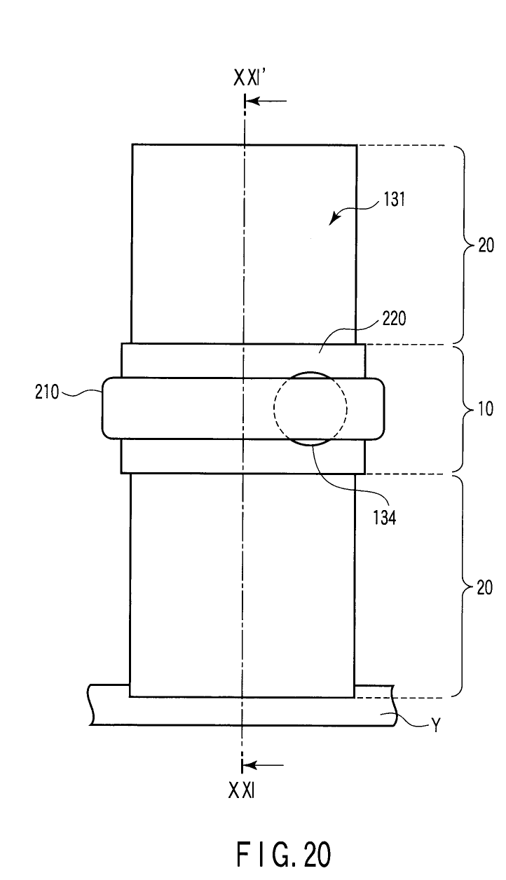

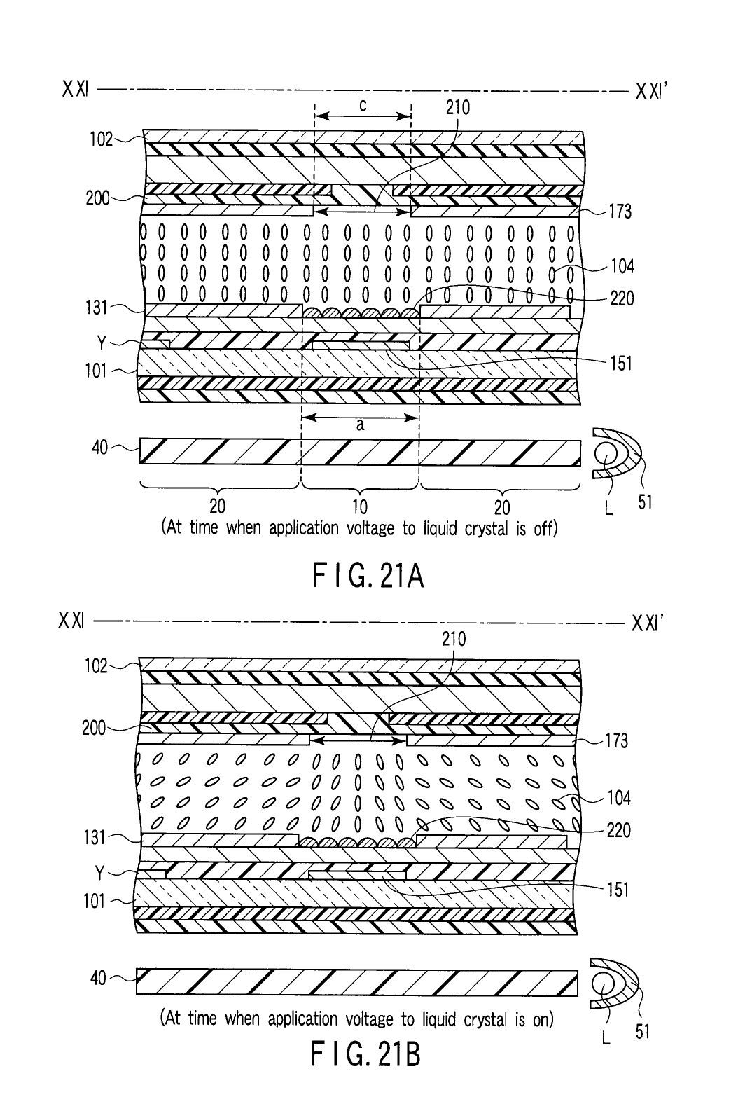

Next, a second comparative example of the liquid crystal display device according to the present embodiment is described with reference to the accompanying drawings. As shown in FIG. 20, FIG. 21A and FIG. 21B, the liquid crystal display device according to the present comparative example is the same as the liquid crystal display device according to the second example, except for the position of the contact hole 134.

Specifically, in the liquid crystal display device according to the present comparative example, the width of the contact hole 134 is greater than the width of the electrode missing part 210. Thus, there is a part where the contact hole 134 does not overlap the electrode missing part 210, and the part where the contact hole 134 overlaps the electrode missing part 210 decreases.

FIG. 22 shows a result of evaluation of the above-described liquid crystal display device. As shown in FIG. 22, in the liquid crystal display device of the second comparative example, the reflectance and contrast ratio at the time of reflective display deteriorated, and the liquid crystal alignment state in the reflective display region 10 was relatively unstable.

Specifically, in the liquid crystal display devices of the first example and the second example, the contact hole 134 is disposed in the reflective display region and the contact hole 134 is disposed so as to overlap the electrode missing part 210 of the counter-electrode 173. Thereby, compared to the prior art, the loss of emitted light can be reduced. This advantageous effect becomes greater as the fineness of images increases. In addition, it is possible to prevent degradation in quality of a screen image, such as persistence or roughness, which occurs due to the phenomenon that the contact hole part, where the alignment is unstable, becomes an optically dark part.

Therefore, the present invention can provide a liquid crystal display device which can prevent occurrence of abnormality in color and gradation in the reflective display region 10, and can suppress degradation in optical characteristics and deterioration in display screen quality.

The present invention is not limited directly to the above-described embodiments. In practice, the structural elements can be modified without departing from the spirit of the invention. For example, in the liquid crystal display device according to the embodiments, the pitch of pixel electrodes in the direction substantially parallel to the short side of the display pixel is about 50 μm. However, if the width of the short side of the pixel electrode 131 is 50 μm or less, when the voltage is applied to the liquid crystal 104, the electric force lines, which are generated near edges of the display pixel PX, are also tilted by the influence of the electrode missing part 210. Thus, the invention is effectively applicable to the liquid crystal display device in which the short-side width of the pixel electrode 131 is 50 μm or less.

In the first and second examples of the liquid crystal display device 1 of the second embodiment, the contact hole 134 is disposed at the central part of the electrode missing part 210. However, the position of the contact hole 134 is not limited to this, and may be disposed at other positions if the contact hole 134 is opposed to the electrode missing part 210 and is disposed within the electrode missing part 210. In this case, too, the degradation in display quality of the liquid crystal display device can be suppressed.

In addition, in the first and second examples of the liquid crystal display device 1 of the second embodiment, the contact hole 134 is opposed to the electrode missing part 210. However, owing to restrictions in design, there may be a case in which the entire contact hole 134 cannot be disposed to be opposed to the electrode missing part 210 because the region where the electrode missing part 210 is disposed in small, for example, as in the case of the second comparative example.

In such a case, the degradation in display quality of the liquid crystal display device can be suppressed by increasing as much as possible the area of the part where the contact hole 134 is opposed to the electrode missing part 210.

In the liquid crystal display device according to the embodiment, the contact hole 134, which connects the pixel electrode 131 and storage capacitance electrode 151, and the electrode missing part 210 are configured to be opposed to each other. Alternatively, the contact hole 117, which connects the pixel electrode 131 and the switching element, and the electrode missing part 210 may be configured to be opposed to each other. Besides, in the case where a common contact hole (not shown) is used to connect the pixel electrode 131 and the storage capacitance electrode 151 and to connect the pixel electrode 131 and the switching element, this common contact hole and the electrode missing part 210 may be configured to be opposed to each other. In these cases, too, the same advantageous effects as with the liquid crystal display devices of the above-described embodiments can be obtained.

Various inventions can be made by properly combining the structural elements disclosed in the embodiments. For example, some structural elements may be omitted from all the structural elements disclosed in the embodiments. Furthermore, structural elements in different embodiments may properly be combined.

What is claimed is:

1. A liquid crystal display device comprising:
an array substrate on which a plurality of signal lines and a plurality of scanning lines, which are perpendicular to the plurality of signal lines, are provided;
switching elements which are provided at intersection portions between the signal lines and the scanning lines and are connected to the signal lines and the scanning lines;
pixel electrodes and storage capacitance electrodes which are disposed in a matrix on the array substrate;
an insulation film which is formed on the switching element and the storage capacitance electrode;
a contact hole which penetrates the insulation film and connects the pixel electrode and the switching element, or the switching element and the storage capacitance electrode;
a counter-substrate which is disposed to be opposed to the array substrate, with a gap being formed therebetween;
a counter-electrode which is formed on the counter-substrate; and
a liquid crystal layer which is held between the array substrate and the counter-substrate and is formed of a liquid crystal with a negative dielectric constant anisotropy, the counter-electrode having an electrode missing part which is disposed at a position that is opposed to the contact hole.

2. The liquid crystal display device according to claim 1, wherein the contact hole which connects the switching element and the pixel electrode and the contact hole which connects the switching element and the storage capacitance electrode are the same contact hole, and the counter-electrode has the electrode missing part which is disposed at a position that is opposed to the contact hole.

3. The liquid crystal display device according to claim 1 or 2, wherein the pixel electrode comprises a transmissive electrode and a reflective electrode, and the electrode missing part is opposed to the reflective electrode.

4. The liquid crystal display device according to claim 3, wherein one of the array substrate and the counter-substrate includes an insulation layer which varies a thickness of the liquid crystal layer, and
the reflective electrode is disposed to overlap a region where the insulation layer is disposed.

5. The liquid crystal display device according to claim 1 or 2, wherein the pixel electrode has a substantially rectangular shape, and a width of a short side of the pixel electrode is 50 μm or less.

6. The liquid crystal display device according to claim 1 or 2, wherein the pixel electrode has a substantially rectangular shape, and
the electrode missing part and the storage capacitance electrode are disposed at a central part in a long side of the pixel electrode and extend substantially in parallel to a short-side direction of the pixel electrode.

7. The liquid crystal display device according to claim 1 or 2, wherein a longitudinal direction of the electrode missing part is substantially parallel to a short-side direction of the pixel electrode.

8. The liquid crystal display device according to claim 1, wherein the contact hole is a contact hole which connects the switching element and the pixel electrode, and the counter-electrode has the electrode missing part which is disposed at a position that is opposed to the contact hole.

9. The liquid crystal display device according to claim 1, wherein the contact hole is a contact hole which connects the switching element and the storage capacitance electrode, and the counter-electrode has the electrode missing part which is disposed at a position that is opposed to the contact hole.
